(19) United States
(12) Patent Application Publication
(10) Pub. No.: US 2013/0339367 A1
(43) Pub. Date: Dec. 19, 2013

(54) METHOD AND SYSTEM FOR PREFERENTIAL ACCESSING OF ONE OR MORE CRITICAL ENTITIES

(71) Applicant: Santhosh Adayikkoth, Bangalore (IN)

(72) Inventor: Santhosh Adayikkoth, Bangalore (IN)

(21) Appl. No.: 13/918,347

(22) Filed: Jun. 14, 2013

(30) Foreign Application Priority Data
Jun. 14, 2012 (IN) 2381/CHE/2012

(51) Int. Cl. G06F 17/30

(52) U.S. Cl. CPC G06F 17/30318
USPC 707/741

(57) ABSTRACT

Embodiment is related to a method and system for preferentially accessing of one or more critical entities. One or more event data sets, related to one or more entities stored in a database, are received from one or more data sources by a processing engine. The entities, which are associated to the received event data sets are identified. The identified entities are compared with a preconfigured list of critical entities to determine at least one of the one or more entities matching with at least one critical entity. The preconfigured list of critical entities is stored in a pattern based selective index. The critical entities are stored in the graph database and indexed by the pattern based selective index. The entities are accessed, using address information associated to the respective entities, from the database when identified entities are matched with the critical entity in preconfigured list of critical entities.

This application claims the benefit of Indian Patent Application Filing No. 2381/CHE/2012, filed Jun. 14, 2012, which is hereby incorporated by reference in its entirety.

### TECHNICAL FIELD

The present disclosure is related to optimal and on time handling of big data. More particularly, the present disclosure is related to a method and a system for preferential access of one or more critical entities and selective handling of one or more event data sets that are related to the one or more critical entities, which are received from one or more real-time data sources in a big data network.

### BACKGROUND

Big data comprises one or more data sets or structures that are very large and complex in nature. The data relating to one or more entities of a big data domain grow in volume and complexity as and when they stream-in from various data sources. The various data sources consists of information related to, but are not limited to, web logs, radio frequency identification (RFID) signals, sensor networks, social networks, online transactions, e-commerce, internet, medical surveillance, archives of photos and videos etc. which are data elements/event data continuously stream-in. Some of these data elements/event data that are thus continuously streaming-in are related to one or more critical entities and therefore need to be handled on time without failure. Scenarios like targeted advertisement (ads), recommendations, customer churn management, fraud prevention, logistics, risk management, and crime prevention etc. are exposed to above mentioned data situations. Present methods used to address these scenarios are complex and inefficient as the data grows to big data proportions. Therefore, conventional techniques makes it difficult to add different and new types of information relating to data element/event data seamlessly to drive interventions on time, as the volume and velocity of the data element/event data streaming-in to big data domain gets in large proportions.

Conventional method uses various tools to handle big data which are more aligned towards offline or batch processing of event data. The various tools include, but are not limited to, parallel processing databases, data-mining grids, distributed file systems, distributed databases, cloud computing platforms and scalable storage systems. This results in minimizing the leveraging of big data for a near real time intervention with minimal latency. Additionally, graph based data models or graph databases are being used in handling the event data associated to the entities in the big data network. Using graph database provides capability to extract and preserve insights through associations. However, it can be trouble some if the graph based data models are used as the primary information base for near real-time systems. Also, the conventional method fails to access the entities based on flown-in the event data.

Hence, there exists a need to develop a system and method that can scale up big data proportions preferentially and access the critical entities among the entities which are relating to the flown-in event data.

### SUMMARY

The shortcomings of the prior art are overcome and additional advantages are provided through the present disclosure. Additional features and advantages are realized through the techniques of the present disclosure. Other embodiments and aspects of the disclosure are described in detail herein and are considered a part of the claimed disclosure.

The present disclosure is related to optimal and on time handling of big data. More particularly, the present disclosure is related to a method for preferential access of one or more critical entities and selective handling of one or more event data sets that are related to the one or more critical entities, which are received from one or more real-time data sources in a big data network. The method comprises steps of receiving one or more event data sets from one or more data sources by a processing engine which is configured in a computing unit. The one or more received event data sets are related to one or more entities stored in a database. Next, the one or more entities associated to the received one or more event data sets are identified. The identified one or more entities are compared with a preconfigured list of critical entities in order to determine at least one of the one or more entities matching with at least one critical entity in the preconfigured list of critical entities. The preconfigured list of critical entities is stored in a pattern based selective index configured in the computing unit. The critical entities are stored in the graph database and indexed in the pattern based selective index. The one or more entities are accessed from the database when the identified one or more entities are matched with the at least one critical entity in the preconfigured list of critical entities. The one or more entities are accessed using address information associated to the respective one or more entities. Particularly, if the identified one or more entities are matched with one or more entities in the preconfigured list of critical entities, the one or more entities is classified as a critical entity, that requires preferential and selective handling. Pattern based selective index provides direct access to the one or more critical entities and their associated one or more event data sets stored in the database, using their address information that is stored in the pattern based selective index and associated along with the one or more critical entities.

The present disclosure provides a system for preferential access of one or more critical entities and the selective handling of one or more event data sets that are related to the one or more critical entities, which are and received from one or more real-time data sources in a big data network. The system comprises one or more real-time data sources and a computing unit. The computing unit comprises a processing engine, a database and a pattern based selective index. The one or more real-time data sources comprise one or more event data sets. The one or more event data sets are related to one or more entities stored in the database. The processing engine receives the one or more event data sets from the one or more data sources. Next, the processing engine identifies the one or more entities which are associated to the received one or more event data sets. The identified one or more entities are compared with a preconfigured list of critical entities in order to determine at least one of the one or more entities matching with at least one critical entity in the preconfigured list of critical entities. The preconfigured list of critical entities is stored in the pattern based selective index. The critical entities are stored in the database and indexed in the pattern based selective index. The one or more entities are accessed from the database when the identified one or more entities are matched with the at least one critical entity in the preconfigured list of critical entities. The one or more entities are accessed using address information associated to the respective one or more entities. Particularly, if the identified one or more entities are matched with one or more entities in the preconfigured list of critical entities, the one or more entities is classified as a critical entity, that requires preferential and selective handling. Pattern based selective index provides direct access to the one or more critical entities and their associated one or more event data sets stored in the database, using their address information that is stored in the pattern based selective index and associated along with the one or more critical entities.

The present disclosure provides a method of indexing one or more critical entities in a pattern based selective index for preferential accessing of one or more critical entities. The method comprises steps of identifying one or more critical entities, which are matching with one or more pattern structure information stored in a pattern catalog. The pattern structure information comprises a plurality of attributes and associations related to particular entity. Then, the identified one or more critical entities are listed in the preconfigured list of critical entities which is configured in a pattern based selective index. The one or more critical entities are stored in a database and are indexed in the pattern based selective index Respective address information is appended to each of the one or more critical entities listed in the preconfigured list of critical entities. The address information points to one of the one or more entities stored in the database, providing direct access to the one or more critical entities and their associated one or more event data sets stored in the database.

The foregoing summary is illustrative only and is not intended to be in any way limiting. In addition to the illustrative aspects and features described above, further aspects, and features will become apparent by reference to the drawings and the following detailed description.

### BRIEF DESCRIPTION OF THE DRAWINGS

The novel features and characteristic of the disclosure are set forth in the appended claims. The embodiments of the disclosure itself, however, as well as a preferred mode of use, further objectives and advantages thereof, will best be understood by reference to the following detailed description of an illustrative embodiment when read in conjunction with the accompanying drawings. One or more embodiments are now described, by way of example only, with reference to the accompanying drawings.

FIG. 1 illustrates a system for preferential accessing of one or more critical entities according to an embodiment of the present disclosure;

FIG. 2 illustrates a flowchart showing an exemplary method for preferential accessing of the one or more critical entities according to an embodiment of the present disclosure; and

FIG. 3 illustrates a flowchart showing method of indexing one or more critical entities in a pattern-based selective index for preferential accessing of the one or more critical entities according to an embodiment of the present disclosure.

The figures depict embodiments of the disclosure for purposes of illustration only. One skilled in the art will readily recognize from the following description that alternative embodiments of the structures and methods illustrated herein may be employed without departing from the principles of the disclosure described herein.

### DETAILED DESCRIPTION

The foregoing has broadly outlined the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific aspect disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

The present disclosure is related to optimal and on time handling of big data. More particularly, the present disclosure is related to a method and a system for preferential access of one or more critical entities and selective handling of one or more event data sets that are related to the one or more critical entities, which are received from one or more real-time data sources in a big data network.

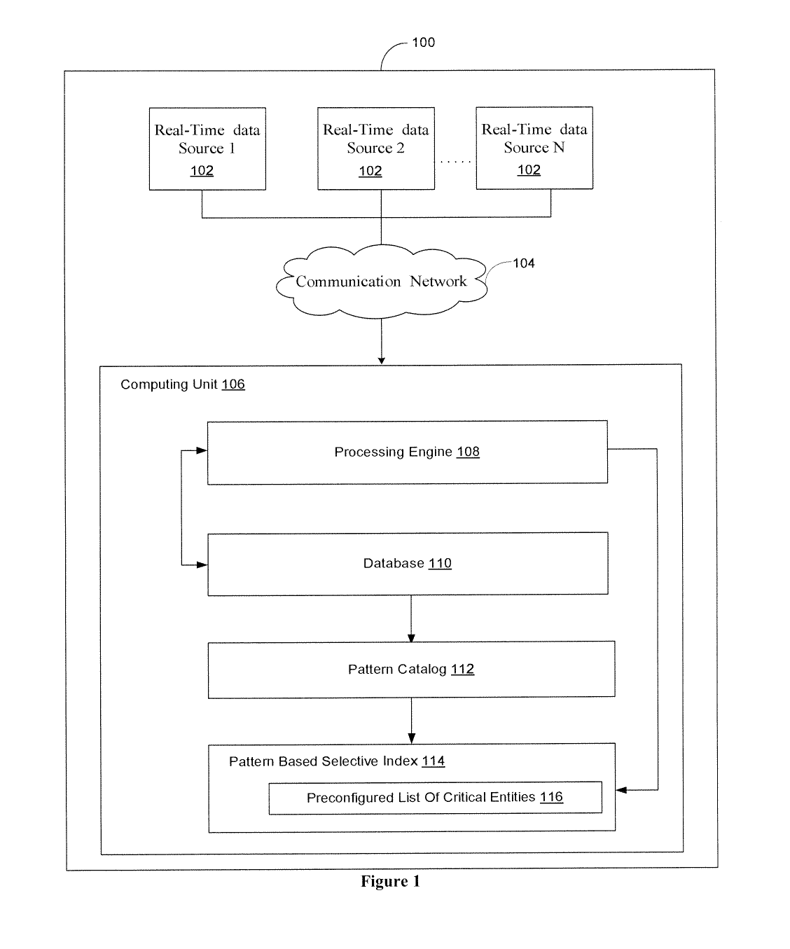

FIG. 1 illustrates a system 100 for preferential accessing of one or more critical entities according to an embodiment of the present disclosure. The system 100 comprises one or more real-time data sources 102, a communication network 104 and a computing unit 106. The one or more real-time data sources 102 include, but are not limited to radio frequency identification (RFID) readers, sensor networks, social networks, software logs, cameras, microphones, aerial sensory sources, mobile devices and other related real-time data sources. The one or more real-time data sources 102 comprises one or more event data sets which are related to one or more entities stored in a database 110. The one or more event data sets is related to at least one of radio frequency identification (RFID) signals, web logs, sensor networks signals, social networks data, internet text and document, call retail records, astronomy, atmospheric science, genomics, biogeochemical, biological, online transactions, e-commerce, medical surveillance, military surveillance and other related event data sets. The computing unit 106 is communicatively connected with the one or more real-time data sources 102 over the communication network 104. The computing unit 106 comprises a processing engine 108, a database 110, a pattern catalog 112, a pattern based selective index 114, a pattern based index builder. (not shown) and a pattern miner (not shown). The one or more entities stored in the database 110 is related to one or more establishments including, but are not limited to financial institutions, commercial establishments, government offices, data security centres, weather forecast centres, manufacturing industries and other establishments. The database 110 is at least one of including but not limiting to a graph database, a relational database, a document based database, a key value database, an in-memory database and other databases capable of storing the one or more critical entities. The pattern catalog 112 of the computing unit 106 stores a plurality of attributes and associations which are related to state and context of the one or more entities that are critical from an enterprise/industry perspective. In an embodiment, the plurality of attributes and associations of the one or more entities varies for different operation domains of one or more establishments. The processing engine 108 receives the one or more event data sets from one or more real-time data sources 102. Upon receiving the one or more event data sets, the one or more entities which are associated to the received one or more event data sets are identified.

Next, the identified one or more entities is compared with a preconfigured list of critical entities 116 in order to determine at least one of the one or more entities matching with at least one critical entity in the preconfigured list of critical entities 116. The preconfigured list of critical entities 116, in general, lists one or more entities that are critical from an enterprise/industry perspective. The preconfigured list of critical entities 116 is in turn stored in the pattern based selective index 114. In an embodiment, the pattern-based selective index 114 for the one or more critical entities is built by the pattern based index builder (not shown) as a tiered index structure. The pattern-based selective index 114 indexes only those one or more entities that are critical from an enterprise/industry perspective and require on time interventions. The pattern based selective index 114 provides a quick availability check of the one or more entities, which are stored in the preconfigured list of critical entities 116.

The address information of the one or more critical entities that are stored in the database are also stored in the pattern based selective index along with the listing of the critical entity in the preconfigured list of critical entities 116. These address information provides direct access to the respective critical entities that are stored on the database 110.

In an embodiment, the one or more entities are accessed on priority basis based on the nature of the plurality of attributes and associations of the respective one or more entities. In an embodiment, after accessing the one or more entities from the database 110, one or more actions are initiated for providing interventions of the at least one of the one or more entities on the received one or more event data sets. The one or more actions is at least one of providing alerts/notification, initiating one or more functions including arranging for shipment, initiating money transfer and any other actions using which user of the computing unit 106 handles critical business situation. In this way, the system 100 handles the one or more event data sets that are flowing-in from the one or more real-time data sources 102 in a selective preferentially manner.

The one or more entities from the database 110 are listed in the preconfigured list of critical entities 116 and indexed as the critical entities in the pattern based selective index 114 based on a plurality of attributes and associations of the respective one or more entities. The pattern based selective index 114 provides a quick availability check of the one or more entities, which are stored in the preconfigured list of critical entities 116. In an embodiment, the plurality of attributes and associations of the one or more entities is stored in the database 110 in a form including but not limited to a graph structure. The graph structure of the one or more entities in the database 110 is built by a graph builder (not shown) of the computing unit 106 based on the data extracted from multiple databases associated with an enterprise, during configuration. The pattern catalog 112 stores pattern structure information of the plurality of attributes and associations of the one or more critical entities in a form including but not limited to a graphical data structure and sequential data structure. In an embodiment, the plurality of attributes and associations of the one or more entities are either extracted from the database 110 by the pattern miner (not shown in the FIG. 1) of the computing unit 106 or manually by a user. Then, the one or more entities are listed as the critical entities in the preconfigured list of critical entities 116 based on match of the plurality of attributes and associations of the entities stored in the database 110 with respective one or more entities stored in the pattern catalog 112. The one or more entities from the database 110 are listed in the preconfigured list of critical entities 116 when the one or more entities are matched with the at least one critical entity in the pattern catalog 112. The address information of the one or more critical entities that are stored in the database 110 are also stored in the pattern based selective index 114 along with the listing of the critical entity in the preconfigured list of critical entities 116. These address information provides direct access to the respective critical entities that are stored on the database 110. In an embodiment, the address structure information is a pointer to the relevant entity of the one or more entities in the database 110 that matches with the one or more critical entities in the preconfigured list of critical entities 116. The address information of the one or more entities are appended to the listing of one or more critical entities in the preconfigured list of critical entities 116 using which the one or more entities in the database 110 are referred or pointed. In an embodiment, the one or more entities are accessed on priority basis based on the nature of the plurality of attributes and associations of the respective one or more entities. In an embodiment, after accessing the one or more entities from the database 110, one or more actions are initiated for providing interventions of the at least one of the one or more entities on the received one or more event data sets. The one or more actions is at least one of providing alerts/notification, initiating one or more functions including arranging for shipment, initiating money transfer and any other actions using which user of the computing unit 106 handles critical business situation. In this way, the system 100 handles the one or more event data sets that are flowing-in from the one or more real-time data sources 102 in a selective preferentially manner.

In an embodiment, no intervention is provided to the one or more entities which are not stored and indexed as the one or more critical entities in the pattern based selective index 114. That is, if the received one or more event data sets are not related to the one or more entities which are the one or more critical entities in the pattern based selective index 114, then there is no intervention provided to any of the one or more entities.

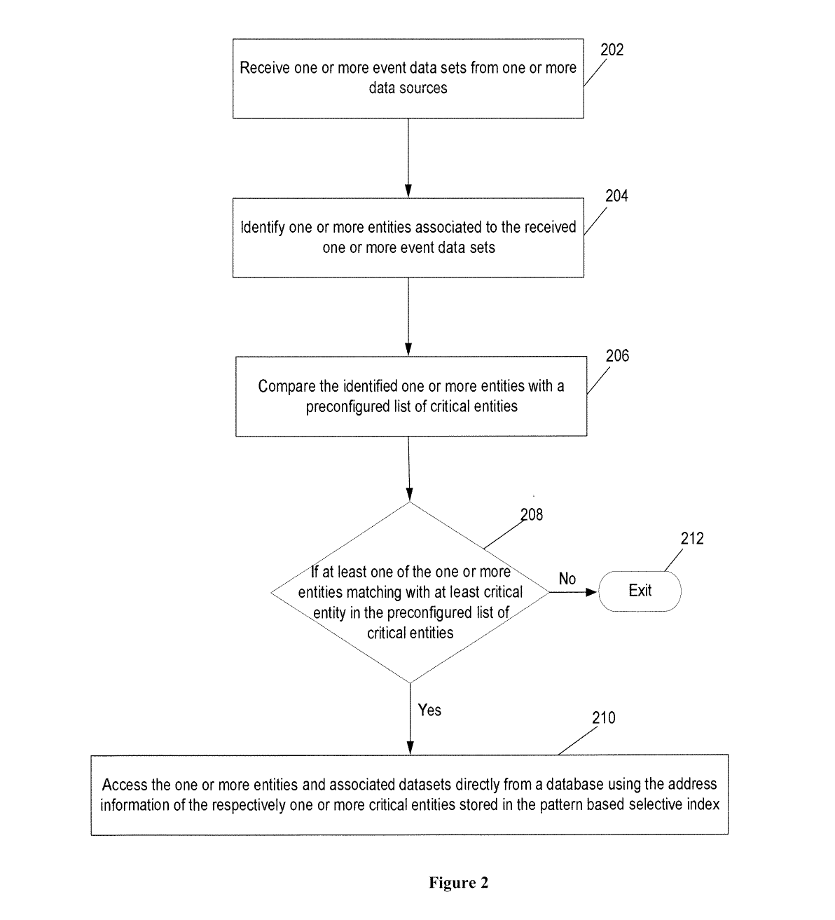

FIG. 2 illustrates a flowchart showing an exemplary method for preferential accessing of the one or more critical entities according to an embodiment of the present disclosure. At step 202, the one or more event data sets is received from the one or more real-time data sources 102 by the processing engine 108 which is configured in the computing unit 106. At step 204, the one or more entities associated to the received one or more event data sets are identified. The one or more event data sets are related to one or more entities stored in the database 110.

For example, considering RFID information from a logistic network the one or more event data sets are RFID signals. The RFID signals are handled by the one or more establishments including, but not limiting to, global supply chains, financial institutions, commercial establishments and government offices. Within the logistics network, there exists one or more product parts or components to which the RFID signals are associated, for example, “part A” is associated to RFID signals. This “part A” is a critical entity for the global supply chain from a business perspective as it is used in the assembly of an important a flagship product “product B”. The criticality of “part A” is defined by the plurality of attributes and associations of “part A”, which includes but not limited to its association to the important and flagship product, “product B”. The plurality of attributes and associations are related to state and context of the one or more entities respectively. That is, for example, the plurality of attributes and associations include but are not limited to market demand, revenue, sourcing demand and other related factors whose pattern structure information is stored in the pattern catalog 112. The plurality of attributes and associations are either extracted from the database 110 or manually uploaded by a user. The plurality of attributes and associations of the one or more entities varies for different operation domains of one or more establishments. Therefore, in this case, since “part A” is a critical entity, the “part A” is listed in the preconfigured list of critical entities 116 and the pattern based selective index 114 have the address information of “part A”. At step 204, when the RFID signals are received, one or more entities associated with the RFID signals are identified. If the RFID signals are related to “part A”, then the identified critical entity is “part A”.

At step 206, the identified one or more entities i.e. “part A” are compared with the preconfigured list of critical entities 116 in order to determine at least one of the one or more entities matching with at least one critical entity in the preconfigured list of critical entities 116. That is, a check is performed to identify if the entities are listed out in the preconfigured list of critical entities 116 in the pattern based selective index 114. The preconfigured list of critical entities 116 is stored in the pattern based selective index 114 configured in the computing unit 106. And the critical entities are stored in the database 106 and indexed in the pattern based selective index 114 based on their plurality of attributes and associations. At step 208, if at least one of the one or more entities matches with at least one critical entity in the preconfigured list of critical entities 116. In this example since the identified critical entity is “part A”, the processing engine 108 handles the incoming RFID signals on priority since the incoming RFID signals are related to a critical entity. Now, at step 210, in order to facilitate prioritized handling and/or intervention of the received RFID signals, the entity “part A” and the event data sets related to “part A” are accessed from the database 110 when it is identified to be present in the preconfigured list of critical entities 116. The entity “part A” and the event data sets related to “part A” are accessed from the database 110 using address information, which is a pointer to its location in the database 110. The accessing is performed on priority basis based on the nature of the plurality of attributes and associations of the respective one or more entities. After accessing, the one or more actions are initiated for providing interventions of the one or more entities i.e. in this case financial institution. The one or more actions is at least one of providing alerts/notification, initiating one or more functions including arranging for shipment, initiating money transfer and any other actions using which user of the computing unit 106 handles critical business situation. When there are no entities matching with the preconfigured list of critical entities 116, then the one or more entities from the database 110 are not accessed as illustrated in the step 212.

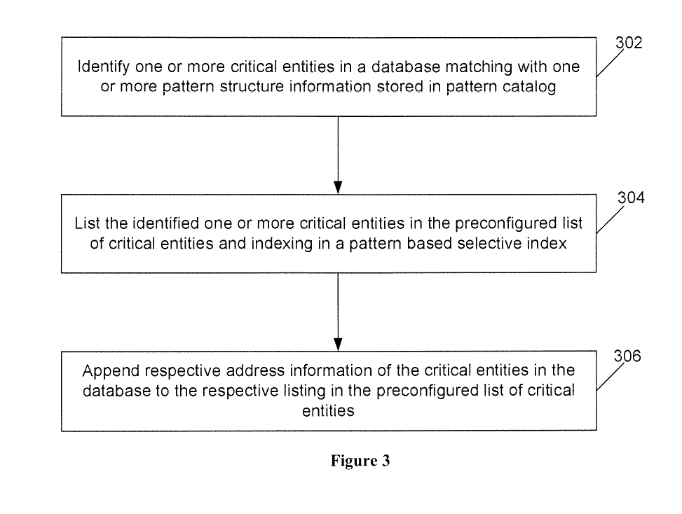

FIG. 3 illustrates a method of indexing one or more critical entities in the pattern based selective index 114 for preferential accessing of the one or more critical entities according to an embodiment of the present disclosure. This indexing is performed during configuration of the pattern based selective index 114. At step 302, steps of identifying the one or more critical entities stored in the database 110 matching with the one or more pattern structure information stored in the pattern catalog 112. The pattern structure information comprises the plurality of attributes and associations related to particular entity in the database 110. Next, at step 304, the identified one or more critical entities stored in the database 110 are listed in the preconfigured list of critical entities 116 which are indexed in the pattern based selective index 114. The one or more critical entities are the one or more entities stored in the database 110. That is, the one or more entities in the database 110 are indexed as the critical entities in the preconfigured list of critical entities 116. Each of the listing of critical entities in the preconfigured list of critical entities 116 is appended with respective address information which points to one of the one or more entities stored in the database 110 as illustrated in the step 306.

Additional features and advantages are realized through various techniques provided in the present disclosure.

The present disclosure finds the application in areas like targeted advertisements, recommendations, customer churn management, fraud prevention, logistic, risk management, crime prevention and other areas.

The present disclosure provides leveraging the one or more event data sets from the big data and handling the one or more event data sets preferentially with minimum latency in real time.

The present disclosure provides interventions of the one or more entities on the one or more event data sets which are important and critical to the one or more entities.

The present disclosure adopts pattern based analysis techniques to identify whether user attention/intervention is required.

The present disclosure categorizes the one or more entities in the preconfigured list of critical entities 116 based on the plurality of attributes and associations.

Furthermore, the functions may be implemented in a variety of programming languages. Such code, as will be appreciated by those of ordinary skilled in the art, may be stored or adapted for storage in one or more tangible machine readable media, such as on memory chips, local or remote hard disks, optical disks or other media, which may be accessed by a processor based system to execute the stored code. Note that the tangible media may comprise paper or another suitable medium upon which the instructions are printed. For instance, the instructions may be electronically captured via optical scanning of the paper or other medium, then compiled, interpreted or otherwise processed in a suitable manner if necessary, and then stored in a computer memory.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

In addition, where features or aspects of the disclosure are described in terms of Markush groups, those skilled in the art will recognize that the disclosure is also thereby described in terms of any individual member or subgroup of members of the Markush group.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

Referral Numerals:

| Reference Number | Description |
|---|---|
| 100 | System |
| 102 | Real-time data sources |
| 104 | Communication network |
| 106 | Computing Unit |
| 108 | Processing Engine |
| 110 | Database |
| 112 | Pattern Catalog |
| 114 | Pattern Based Selective Index |
| 116 | Preconfigured List Of Critical Entities |

We claim:

1. A method for preferential accessing of one or more critical entities, said method comprising:
receiving by a data access computing device one or more event data sets from one or more real-time data sources, wherein the one or more event data sets are related to one or more entities stored in a database;
identifying by the data access computing device the one or more entities which are associated to the received one or more event data sets;
comparing by the data access computing device the identified one or more entities with a preconfigured list of critical entities in order to determine at least one of the one or more entities matching with at least one critical entity in the preconfigured list of critical entities, wherein the preconfigured list of critical entities is stored in a pattern based selective index within the data access computing device, wherein the critical entities are stored in the database and indexed in the pattern based selective index; and
accessing by the data access computing device the one or more entities and associated datasets from the database when the identified one or more entities are matched with the at least one critical entity in the preconfigured list of critical entities, wherein the one or more entities are accessed using an address information associated to the respective one or more entities.

2. The method as claimed in claim 1 further comprising initiating by the data access computing device one or more actions for providing interventions of the at least one of the one or more entities.

3. The method as claimed in claim 1, wherein the one or more entities are listed as the critical entities in the preconfigured list of critical entities based on a plurality of attributes and associations of the respective one or more entities.

4. The method as claimed in claim 1, wherein the one or more entities are indexed as the critical entities in the pattern based selective index based on the plurality of attributes and associations of the respective one or more entities.

5. The method as claimed in claim 1, wherein the accessing is performed on priority basis based on the nature of the plurality of attributes and associations of the respective one or more entities.

6. The method as claimed in claim 3, wherein the plurality of attributes and associations are related to state and context of the one or more entities respectively, wherein the plurality of attributes and associations are stored in a pattern catalog configured in the data access computing device.

7. The method as claimed in claim 1, wherein the plurality of attributes and associations of the one or more entities varies for different operation domains of one or more establishments.

8. The method as claimed in claim 1, wherein the pattern based selective index for one or more critical entities is built by a pattern based index builder.

9. The method as claimed in claim 5, wherein the pattern catalog stores pattern structure information of the plurality of attributes and associations in a form selected from at least one of graphical data structure and sequential data structure.

10. The method of claim 3, wherein the plurality of attributes and associations of the one or more entities are either extracted from the database by a pattern miner or manually by a user.

11. The method as claimed in claim 1, wherein the one or more real-time data sources is selected from at least one of radio frequency identification (RFID) readers, sensor networks, social networks, software logs, cameras, microphones, aerial sensory sources, mobile devices or other related real-time data sources.

12. The method as claimed in claim 1, wherein the one or more event data sets is related to at least one of radio frequency identification (RFID) signals, web logs, sensor networks signals, social networks data, internet text and document, call retail records, astronomy, atmospheric science, genomics, biogeochemical, biological, online transactions, e-commerce, medical surveillance, military surveillance or other related event data sets.

13. The method as claimed in claim 1, wherein the one or more entities stored in the database is related to one or more establishments, wherein the one or more establishments comprises one or more of a financial institutions, commercial establishments, government offices, data security centers, weather forecast centers, manufacturing industries or other establishments.

14. The method as claimed in claim 1, wherein the one or more actions is at least one of providing alerts or notification, initiating one or more functions including arranging for shipment, initiating money transfer or any other actions using which user of the computing unit handles critical business situation.

15. The method as claimed in claim 1, wherein the database is one or more of a graph database, a relational database, a document based database, a key value database, an in-memory database or other databases capable of storing the one or more critical entities.

16. A data access computing device configured to perform steps comprising:
receiving one or more event data sets from one or more real-time data sources, wherein the one or more event data sets are related to one or more entities stored in a database;
identifying the one or more entities which are associated to the received one or more event data sets;
comparing the identified one or more entities with a preconfigured list of critical entities in order to determine at least one of the one or more entities matching with at least one critical entity in the preconfigured list of critical entities, wherein the preconfigured list of critical entities is stored in a pattern based selective index, wherein the critical entities are stored in the database and indexed in the pattern based selective index; and
accessing the one or more entities and associated datasets from the database when the identified one or more entities are matched with the at least one critical entity in the preconfigured list of critical entities, wherein the one or more entities are accessed using an address information associated to the respective one or more entities.

17. The device of claim 16, wherein the one or more comprises one or more of a radio frequency identification (RFID) readers, sensor networks, social networks, software logs, cameras, microphones, aerial sensory sources, mobile devices or other related real-time data sources.

18. The device of claim 16, wherein the one or more entities stored in the database is related to one or more establishments, wherein the one or more establishments comprises one or more of a financial institutions, commercial establishments, government offices, data security centers, weather forecast centers, manufacturing industries or other establishments.

19. The device of claim 16, wherein the database is one or more of a graph database, a relational database, a document based database, a key value database, an in-memory database or other databases capable of storing the one or more critical entities.

20. A method of indexing one or more critical entities in a pattern based selective index for preferential accessing of one or more critical entities, said method comprising:
identifying by a data access computing device one or more critical entities in a database matching with one or more pattern structure information stored in a pattern catalog, wherein the pattern structure information comprises a plurality of attributes and associations related to particular entity;
listing by the data access computing device the identified one or more critical entities in the preconfigured list of critical entities and indexing the preconfigured list of critical entities in a pattern based selective index, wherein the one or more critical entities is stored in a database; and
appending by the data access computing device a respective address information to the corresponding one or more critical entities in the preconfigured list of critical entities, wherein the address information points to one of the one or more entities stored in the database.
